(19) United States
(12) Patent Application Publication
(10) Pub. No.: US 2012/0068429 A1
(43) Pub. Date: Mar. 22, 2012

(54) STABILIZER, AND METHOD OF MAKING A STABILIZER

(75) Inventors: WULF HÄRTEL, Bad-Oeynhausen (DE); Ullrich Hammelmaier, Paderborn (DE); Peter Koczar, Wiesbaden (DE)

(73) Assignee: Benteler Automobiltechnik GmbH, Paderborn (DE)

(21) Appl. No.: 13/153,876

(22) Filed: Jun. 6, 2011

(30) Foreign Application Priority Data
Jun. 7, 2010 (DE) 102010022866.4-12

(51) Int. Cl. B60G 21/055; B32B 37/12; B32B 37/06; B32B 37/24

(52) U.S. Cl. 280/124.106; 156/242

(57) ABSTRACT

In a method of making a stabilizer, a rubber molding is vulcanized onto an inner side of an outer shell to produce a rubber bearing. After coating a stabilizer bar, the rubber bearing is vulcanized onto the stabilizer bar in a joining zone while maintaining the rubber bearing under a defined tension using a biasing tool. After vulcanization and removal of the biasing tool, a bearing bracket is connected in surrounding relationship to the rubber bearing while maintaining the rubber bearing under a defined tension.

### CROSS-REFERENCES TO RELATED APPLICATIONS

This application claims the priority of German Patent Application, Serial No. 10 2010 022 866.4-12, filed Jun. 7, 2010, pursuant to 35 U.S.C. 119(a)-(d), the content of which is incorporated herein by reference in its entirety as if fully set forth herein.

### BACKGROUND OF THE INVENTION

The present invention relates to a stabilizer, and to method of making such a stabilizer.

The following discussion of related art is provided to assist the reader in understanding the advantages of the invention, and is not to be construed as an admission that this related art is prior art to this invention.

In general, stabilizers are connected to the vehicle body using rubber bearings such as for example torsion bar shoulder bearings of stabilizer bearings. In an attempt to reduce wear and to increase the life of stabilizers, it has been proposed to additionally post-vulcanize rubber bearings so as to be able to use an adhesion promoter for realizing a material joint between the rubber bearing and for example the stabilizer.

It would be desirable and advantageous to provide an improved method for making a stabilizer to obviate prior art shortcomings.

### SUMMARY OF THE INVENTION

According to one aspect of the present invention, a method of making a stabilizer includes the steps of vulcanizing a rubber molding onto an inner side of an outer shell to produce a rubber bearing, coating a stabilizer bar, vulcanizing the rubber bearing onto the stabilizer bar in a joining zone while maintaining the rubber bearing under a defined tension using a biasing tool, and connecting a bearing bracket in surrounding relationship to the rubber bearing while maintaining the rubber bearing under a defined tension.

According to another advantageous feature of the present invention, the rubber bearing can be vulcanized onto the stabilizer bar in a furnace or by induction heating. Vulcanization and the heat necessary for vulcanization may also be implemented through hot-air application or using an infrared source.

The rubber bearing may be comprised of one or several rubber moldings which are vulcanized onto an outer shell or of a rubber molding that is vulcanized onto several outer shell parts.

The biasing tool used on the stabilizer for maintaining the rubber bearing under tension during vulcanizing may be a slotted single piece element placed in surrounding relationship to the rubber bearing. The ends of the biasing tool bounding the slot are connected to one another such as to establish the wanted defined tension. Advantageously, the biasing tool has an inner side which rests flatly on an outer side of the rubber bearing to ensure an even biasing force dispersed across the entire rubber bearing.

As an alternative to the single-piece construction, the biasing tool may also be made of two-part construction comprised of two tool halves in the form of half-shells which grip around the rubber bearing. The rubber bearing is hereby maintained under the applied defined tension while both bearing shell halves are connected.

The defined tension introduced into the rubber bearing while the rubber bearing is vulcanized onto the stabilizer rod is different than the tension under which the rubber bearing is held by the bearing bracket after final assembly. The tension applied for the vulcanizing process decreases at least in part during vulcanization. Once the biasing tool is removed, the rubber bearing is relaxed.

The biasing tool may have an inner contour which is suited to an inner contour of the bearing shell intended for assembly.

Following vulcanization and removal of the biasing tool, the bearing shell embraces the rubber bearing about its circumference. Advantageously, the bearing bracket rests flatly with its inner side upon the outer side of the rubber bearing. While the bearing bracket is positioned, the rubber bearing is maintained under a defined tension.

In addition to the thus established connection by friction fit, the rubber bearing may also be connected to the bearing bracket by a material joint. Currently preferred is a glued connection between the rubber bearing and the bearing bracket. The adhesive layer may be applied prior to assembly of the bearing bracket upon the inner side of the bearing bracket and/or on the outer side of the rubber bearing,

According to another aspect of the present invention, a stabilizer includes a stabilizer bar, a rubber bearing including a rubber molding and an outer shell vulcanized onto the rubber molding, the rubber bearing being vulcanized onto the stabilizer bar, and a bearing bracket in surrounding relationship to the rubber bearing and maintaining the rubber bearing under predefined tension.

The outer shell rests advantageously flatly with its inner side on the outer side of the rubber molding. Of course, several outer shell parts may be arranged on the outer side of the rubber bearing. Gaps may be provided for example between the outer shell parts formed in the shape of half-shells.

According to another advantageous feature of the present invention, the outer shell may have a contour conforming to an inner contour of the bearing shell. As an alternative, the outer shell may also have recesses for receiving projections or grooves of the bearing bracket which are directed to the stabilizer bar.

According to another advantageous feature of the present invention, the outer shell may be made of metal or plastics.

According to another advantageous feature of the present invention, a rubber coating may be applied onto an outer side of the outer shell.

The rubber bearing may be made of single-piece construction or multipart construction. Advantageously, the rubber bearing may be made of two rubber bearing halves.

The bearing bracket grips around the rubber bearing advantageously in such a manner that the inner side of the bearing bracket rests flatly on the outer side of the rubber bearing for establishing a uniform tension. Advantageously, the bearing bracket has a length which is suited to a length of the rubber bearing. The end faces of the rubber bearing pointing in longitudinal direction do not come into contact in this embodiment with the bearing bracket.

Of course, the length of the bearing bracket may also differ from the length of the rubber bearing or may have recesses. It may also be conceivable to provide the bearing bracket with radially inwardly curved portions which rest, at least in part, on one or both end faces of the rubber bearing.

Advantageously, the rubber bearing of the stabilizer is connected with the bearing bracket not only by friction fit but also by a material joint. An example of a material joint is glued connection.

A method of making a stabilizer in accordance with the invention and a stabilizer made by such a process have the advantage that the bearing bracket is installed after the rubber bearing has been vulcanized onto the stabilizer bar so that the rubber bearing can be precisely maintained under a predefined tension.

By maintaining the rubber bearing under a defined tension via the bearing bracket, problems relating to relative movements and the presence of noise, vibrations, and harshness (NHV) between the bearing bracket and the rubber bearing can be eliminated, thereby increasing the service life of stabilizers according to the present invention. At the same time, process reliability with respect to maintaining the rubber bearing under tension is superior. A method according to the present invention is also applicable for passive as well as active stabilizers.

### BRIEF DESCRIPTION OF THE DRAWING

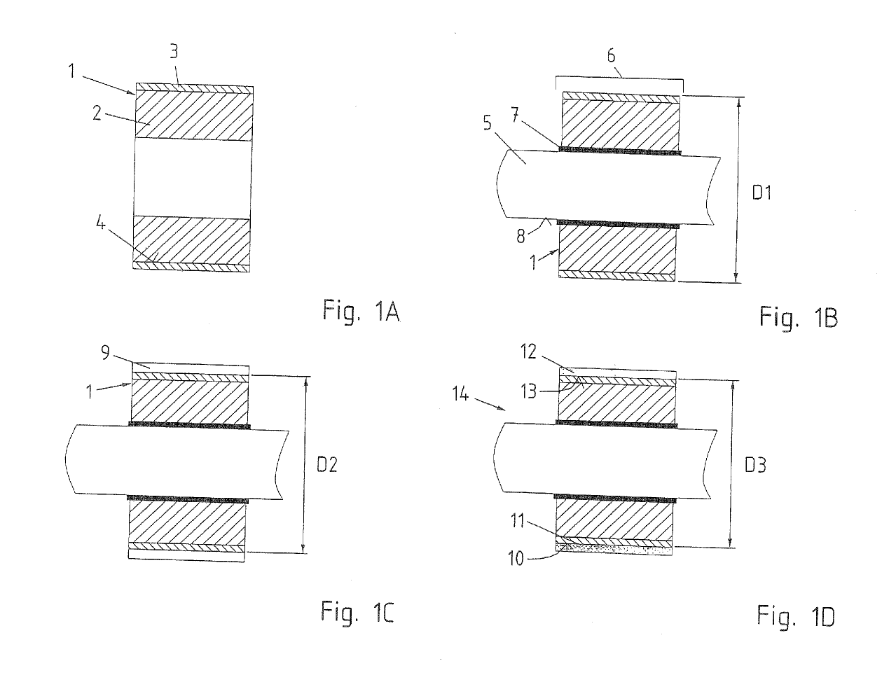

Other features and advantages of the present invention will be more readily apparent upon reading the following description of currently preferred exemplified embodiments of the invention with reference to the accompanying drawing, in which FIGS. 1A to 1D show cross sectional views of various stages of a method of producing a stabilizer in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1A, there is shown a cross sectional view of a rubber bearing, generally designated by reference numeral 1 and comprised of a rubber molding 2 and an outer shell 3. The rubber bearing 1 is made in one piece and is obtained by vulcanizing the rubber molding 2 onto an inner side 4 of the outer shell 3.

FIG. 1B shows the presence of a stabilizer bar 5, with the rubber bearing 1 being arranged upon the stabilizer bar 5. An adhesion promoter 7 is applied in the form of a coating preferably upon a peripheral side 8 of the stabilizer bar 5 before attachment of the rubber bearing 1 in a joining zone 6 between the rubber bearing 1 and the stabilizer bar 5.

As shown in FIG. 10, the rubber bearing 1 is maintained under a defined tension by a biasing tool 9. The tension decreases at least in part during the vulcanization process. Reference sign D1 indicates in FIGS. 1A and 1B a diameter in a relaxed state of the rubber bearing 1, whereas reference sign D2 indicates in FIG. 10 a diameter of the rubber bearing 1 under tension, and it can be seen that the diameter D2 is smaller than the diameter D1. The arrangement of rubber bearing 1, stabilizer bar 5, and biasing tool 9 is then heated in a furnace or heated by induction heating to vulcanize the rubber bearing 1 via the adhesion promoter 7 onto the stabilizer bar 5 to establish a material joint between the rubber bearing 1 and the stabilizer 5.

After vulcanization, the biasing tool 9 is removed from the rubber bearing 1, and an adhesive coating 11 is applied on the outer side 10 of the rubber bearing 1. Thereafter, as shown in FIG. 1D, a bearing bracket 12 is placed around the rubber bearing 1 while the bearing bracket 12 maintains the rubber bearing 1 under a defined tension at the same time.

As a result of shrinkage of the rubber bearing 1 encountered during vulcanization, the diameter D2 decreases even further as the bearing bracket 12 applies a defined tension. This reduced diameter is designated in FIG. 1D as D3. The adhesive coating 11 establishes a material joint between the outer side 10 of the rubber bearing 1 and an inner side 13 of the bearing bracket 12. As a result, a stabilizer 14 is realized which is secured against relative movements between the bearing bracket 12 and the rubber bearing 1.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of making a stabilizer, comprising the steps of:
vulcanizing a rubber molding onto an inner side of an outer shell to produce a rubber bearing;
coating a stabilizer bar;
vulcanizing the rubber bearing onto the stabilizer bar in a joining zone while maintaining the rubber bearing under a defined tension using a biasing tool; and
connecting a bearing bracket in surrounding relationship to the rubber bearing while maintaining the rubber bearing under a defined tension.

2. The method of claim 1, wherein the rubber bearing is vulcanized onto the stabilizer bar in a furnace.

3. The method of claim 1, wherein the rubber bearing is vulcanized onto the stabilizer bar using induction heating.

4. The method of claim 1, wherein the rubber bearing is connected to the bearing bracket by a material joint.

5. The method of claim 1, wherein the rubber bearing is connected to the bearing bracket by gluing.

6. A stabilizer, comprising:
a stabilizer bar;
a rubber bearing including a rubber molding and an outer shell vulcanized onto the rubber molding, said rubber bearing being vulcanized onto the stabilizer bar; and
a bearing bracket in surrounding relationship to the rubber bearing and maintaining the rubber bearing under predefined tension.

7. The stabilizer of claim 6, wherein the rubber bearing is connected to the bearing bracket by a material joint.

8. The stabilizer of claim 6, wherein the rubber bearing is connected to the bearing bracket by gluing.

9. The stabilizer of claim 6, wherein the outer shell is made of metal or plastics.

10. The stabilizer of claim 6, further comprising a rubber coating applied onto an outer side of the outer shell.

11. The stabilizer of claim 6, wherein the rubber bearing is made of rubber bearing halves.
